(19) United States
(12) Patent Application Publication
(10) Pub. No.: US 2006/0253711 A1
(43) Pub. Date: Nov. 9, 2006

(54) Biometric safety and security system

(76) Inventor: Charles Kallmann, Provo, UT (US)

Correspondence Address: ALBERT O COTA, 5460 WHITE OAK AVE, SUITE A-331, ENCINO, CA, 91316, US

(21) Appl. No.: 11/418,959

(22) Filed: May 5, 2006

Related U.S. Application Data
(60) Provisional application No. 60/678,829, filed on May 9, 2005.

(51) Int. Cl. H04K 1/00

(52) U.S. Cl. 713/186

(57) ABSTRACT

A biometric safety and security system (10) that is designed to prevent a person that is inebriated or that is not assigned the use of a particular vehicle ignition key (170) from starting the vehicle. The system (10) utilizes an enclosure (50) that houses an electronics circuit (12) that includes a microcontroller (14), a fingerprint scanner (26), a speech verifier (28), a breath analyzer (29) and the ignition key (170) which is normally retracted into the enclosure (50). To extract the key (170) a person must verify their identity by means of the fingerprint scanner (26) and/or the speech verifier (28), and also verify their sobriety by means of the breath analyzer (29). If the person's identity and sobriety are verified a signal is sent to the microcontroller (14) where a signal is produced that activates a motor interface (32), that operates a d-c motor (34) that extracts the key from the enclosure (50).

This application claims priority of Provisional Patent Application Ser. No. 60/678,829 filed on May 09,2005.

### TECHNICAL FIELD

The invention generally pertains to vehicle safety and security systems, and more particularly to a biometric safety and security system that controls the operation of a vehicle by allowing an ignition key to be used only after a person assigned to use the key has had their identity verified and has passed a sobriety test.

### BACKGROUND ART

Over the years the automotive industry, in an attempt to diminish the ever growing losses due to car theft and car jacking, has introduced technology that utilizes a key having electronic means to create a transponder system that can validate an authenticated key to a specific vehicle. This type of key transponder system is often the primary means of providing vehicle security. Following this development, the industry added other actions onto a key, or a key-fob, such as the ability to lock, unlock, open the trunk, trigger a panic alarm and to remotely start the vehicle. All of these developments using the key have served valuable purposes and have led to further more sophisticated methodologies using the key as a carrier. State of the art technology has now evolved to the point where a tiny integrated circuit can store more data and trigger more actions than a roomful of computers could a relatively short time ago.

Many automobile companies, as well as designers and R&D teams, have come to the conclusion that the actions using a key are sufficient, and therefore no further development is necessary. Unfortunately, the companies, designers and R&D teams have overlooked one of the most significant problems inherent to automobiles today, which is driving while inebriated.

Although, state and local governments have attempted to address the problem of drunk driving, especially among people who have been arrested multiple times for drunk driving, the problem continues to rise. The basic reason for this is because if a person who is inebriated decides that he or she is going to drive, there is no way to stop them. There have been attempts to monitor a person's location and to determine whether a person has injested alcohol within a certain timeframe, but again, it seems the only way to actually stop an inebriated person from driving is to have a system that operates 24-7 to make it physically impossible to start a vehicle.

The key to this problem is the vehicle ignition key. By using existing technology, the inventive biometric safety and security system (SafKey™) described herein utilizes a key that can be used to provide both the previously-mentioned security features, as well as stopping inebriated drivers from starting their vehicles. If an inebriated person is unable to use a key to start their vehicle, the ability to drive is significantly diminished. A key that can provide security features and deter drunk driving would lessen the effects of untimely and countless deaths and destruction of property. As well as the attendant misery, financial loss and suffering that accompanies drunk driving and car theft.

In summary, the following data taken from the San Diego Tribune, May 10, 2002 is self-explanatory.

Consider 41,821 lives lost each year plus 5.3 million injured (at an average of $10,562 per injury). Should SafKey™ save a minimum of ten thousand lives at the estimated $975,000 per death and fifty thousand injuries, very conservatively speaking, the cost savings would be:

1. 10,000 deaths valued at nine hundred seventy five thousand ($975,000) dollars each, total of ninety seven million five hundred thousand ($97,500,000) dollars in annual savings.

2. 50,000 injuries valued at ten thousand five hundred sixty two ($10,562) dollars per injury, a savings of fifty two million eight hundred ten thousand ($52,810,000) dollars per year.

3. Total annual savings $150,310,000.00.

A search of the prior art did not disclose any literature or patents that read directly on the instant invention. However, the following U. S. patents are considered related:

| PATENT NO. | INVENTOR | ISSUED |
|---|---|---|
| 6,229,908 | Edmonds III, et al | 8 May 2001 |
| 4,996,161 | Conners, et al | 26 Feb. 1991 |
| 4,678,057 | Elfman, et al | 7 Jul. 1987 |
| 4,093,945 | Collier, et al | 6 Jun. 1978 |

The 6,229,908 patent discloses an ignition interlock for preventing operation of equipment when an operator's blood-alcohol content is above a threshold value. The interlock has a blood-alcohol detector that measures intensities of wavelengths of light emerging from a finger. A microprocessor correlates these intensities with the person's blood-alcohol content, determines whether the content is above a preset threshold level, and prevents the equipment from being operated unless the blood-alcohol content is below the threshold. The interlock also has a fingerprint image generator which reflects light off the finger and scans the fingerprint to form a scanned image. The microprocessor compares the scanned image to a prestored image of a principal operator and compares the two images to determine whether the images match. The fingerprint and blood-alcohol analyses occur substantially simultaneously.

The 4,996,161 patent discloses a breath alcohol testing system for use in unsupervised blood alcohol testing. The system includes a face mask for receiving a breath sample, components to confirm the identity and components to insure that this identity act and breath delivery are performed by the same person. The system requires that the face mask continuously engage the face of the subject between identity conformation and breath delivery.

The 4,678,057 patent discloses an apparatus and a method for analyzing a breath sample. A transducer senses the pressure, temperature and humidity of the breath sample and in response generates a breath signature signal. A sensor detects the alcohol content of the breath sample and in response generates an alcohol signal. A first comparator compares the breath signature signal with a breath reference, and in response. generates either a valid signal if the signals substantially match or an invalid signal if the signals do not substantially match. A second comparator compares the alcohol signal with an alcohol reference, and in response generates either a passing signal or a failing signal depending on whether or not the threshold level is exceeded.

The 4,093,945 patent discloses a breath testing system for alcohol intoxication breath testing. The system includes a breath input unit, a controller which delivers a 5 sample of deep lung breath to an evaluator including an alcohol detector, and an output apparatus. A passing signal cannot be obtained unless a predetermined continuous and uninterrupted breath flow has occurred and the resulting sample tests below a predetermined alcohol concentration. The system is disclosed for use in a motor vehicle, wherein failure to pass the test modifies the operation of the vehicle.

For background purposes and as indicative of the art to which the invention relates, reference may be made to the following remaining patents found in the search:

| PATENT NO. | INVENTOR | ISSUED |
|---|---|---|
| 5,973,592 | Flick | 26 Oct. 1999 |
| 5,808,564 | Simms, et al | 15 Sep. 1998 |
| 5,739,747 | Flick | 14 Apr. 1998 |

### DISCLOSURE OF THE INVENTION

The biometric safety and security system (hereinafter SafKey™) is designed to prevent a person who is inebriated from driving a vehicle. The SafKey™ in its basic design configuration is comprised of:

a) an electronics circuit that is housed within an enclosure which also encloses 2 5 a key that when not in use is in a retracted position. The key can be extracted from the enclosure only after a person assigned to use the key has had their identity verified and their blood alcohol content (BAC) verified to be below a preset legal limit,

b) means for extracting and retracting the key,

c) means for verifying the identity of the person, and

d) means for verifying that the person's BAC has not exceeded a preset legal limit.

The SafKey™ allows a key to be used without any modification to the vehicle, and can be mechanized as either an OEM product or as a retrofitable option.

The SafKey™ methodology is able to dramatically lessen accidents on our highways, theft of vehicles; aircraft or boats; and increase the security of homes, offices and other areas of security dependency. Additionally, the SafKey™ provides the capability for reducing untold billions of dollars spent on insurance claims, medical expenses, crippling and dismemberment, property theft, unauthorized entry and security loss. The SafKey™ is simple, cost effective, dependable and has the potential to save lives, cut costs and diminish vehicle accidents and crimes where a key is required to turn on/off or permit entry.

In view of the above disclosure, the primary object of the invention is to produce a biometric safety and security system that prevents an inebriated driver from operating a vehicle.

In addition to the primary object of the invention it is also an object of the invention to produce a biometric safety and security system that:

can be used on all vehicles with the exception of tactical military vehicles,

can be used with keys for homes and offices,

requires no modifications or attachments to a vehicle,

is simple to use, dependable and reliable,

can be inserted in any type ignition switch that is mounted either horizontally, vertically, on a column or on a dashboard,

addresses access control on a retrofit bases to provide legacy portal access control, and

is cost effective from both a manufacturer's and consumer's point of view.

These and other objects and advantages of the present invention will become 2 5 apparent from the subsequent detailed description of the preferred embodiment and the appended claims taken in conjunction with the accompanying drawings.

### BRIEF DESCRIPTION OF THE DRAWINGS

FIG. 1 is a block diagram of the SafKey™ electronics circuit.

FIG. 2 is a block-flow diagram of the SafKey™ firmware.

FIG. 3 is a perspective view of an ignition key extracted from the SafKey™ enclosure.

FIG. 4 is a perspective view of an ignition key retracted into the SafKey™ enclosure.

FIG. 5 is an exploded view of the SafKey™.

FIG. 6 is a front elevational view of the SafKey™ enclosure.

FIG. 7 is a side elevational view of a key traversing structure that is located in the SafKey™ enclosure

FIG. 8 is a rear elevational view of the SafKey™ enclosure.

### BEST MODE FOR CARRYING OUT THE INVENTION

The best mode for carrying out the invention is presented in terms of a preferred embodiment for a biometric safety and security system 10 (hereinafter “SafKey™ 10”) is designed to allow a vehicle to be started only after a vehicle driver's identity has been verified and the driver's Blood Alcohol Content (BAC) has been verified to be below a preset legal limit. The SafKey™ 10 utilizes an enclosure that is dimensioned to contain all the electronic circuits and mechanical elements that fuiction in combination with a firmware program. The SafKey™ 10 allows a vehicle ignition key to be extracted from the enclosure when access is allowed or to maintain the ignition key in a retracted position within the enclosure when access is denied. Note that the SafKey™ 10 concept is also applicable to other keyed-entry systems such as house/building keys and other security key-entry structures. Also, for the purpose of this disclosure the term “vehicle” is intended to encompass automobiles, trucks, boats, buses, trains, aircraft and non-tactical military vehicles.

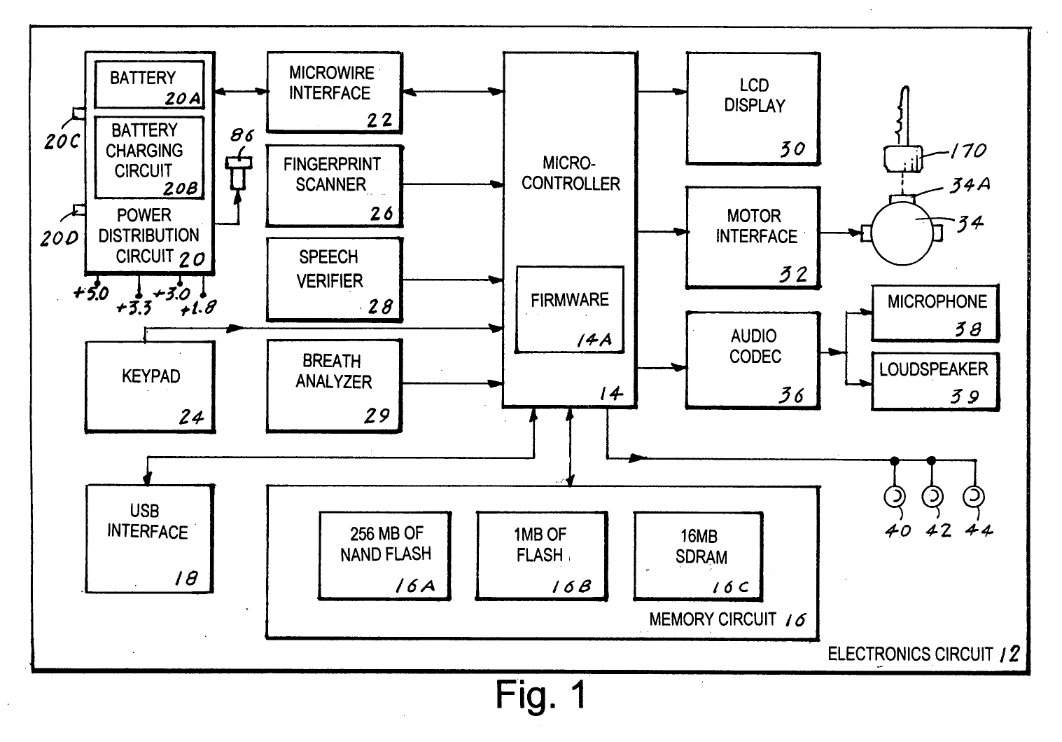

The preferred embodiment of the SafKey™ 10, as shown in FIGS. 1-8, is comprised of the two major elements: an electronics circuit 12 and an enclosure 50 that houses the electronics circuit 12.

The electronics circuit, as shown in block form in FIG. 1, is comprised of the following major elements: a microcontroller 14 that is operated by firmware 14A, a memory circuit 16, a USB interface 18, a power distribution circuit 20, a microwire interface 22, a keypad 24, a fingerprint scanner 26, a speech verifier 28, a breath analyzer 29, an LCD display 30, a motor interface 32, a d-c motor 34 that operates an ignition key 170, an audio codec 36, a microphone 38, a speaker 39, a green LED 40, an amber LED 42 and a red LED 44. The combined elements provide the means for retracting and extracting the ignition key 170, the means for verifying the identity of a person assigned to use the key 170, and the means for verifying that the person's BAC has not exceeded the preset legal limit.

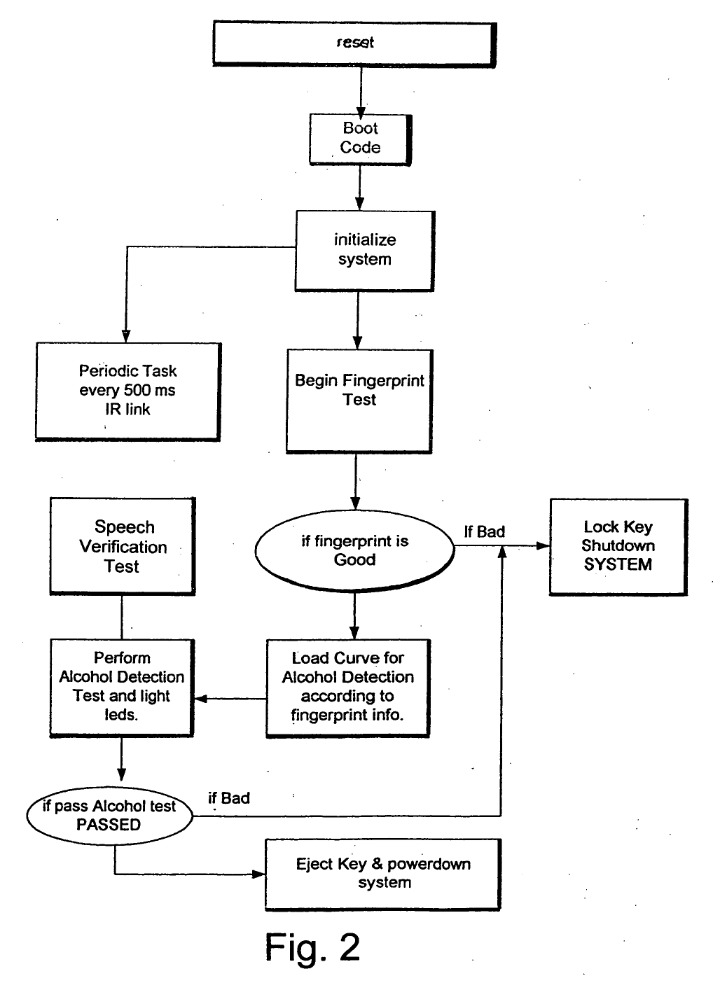

The microcontroller 14 which is operated by firmware 14A, as shown in FIG. 1, functions as the central core of the electronics circuit 12 and as the processor for directly or indirectly operating all the elements that comprise the electronics circuit 12, as 1 5 also shown in FIG. 1. A typical firmware 14A is illustrated in a block-flow diagram in FIG. 2.

The microcontroller 14 is preferably comprised of an ATMEL AT91RM9200 32/16-bit ARM processor which operates at 18 Mhz. The microcontroller controls the system processing, peripheral control, data storage and transfer, and power management, and is supported by a memory circuit 16 that includes 256 MB of NAND Flash 16A, 1MB of Flash 16B, and 16 MB of synchronous dynamic random access memory (SDRAM) (16C). The 256 MB of NAND Flash 16A typically stores and retrieves personal and other vital data for up to 60 persons. The data includes:

name and date of birth,

address, telephone number and e-mail address,

personal identification: eye color, height, weight, skin color, identifying marks i.e., scars and/or tattoos,

fingerprint(s),

speech pattern profile,

color picture(s),

driver's license number,

social security and ID number,

service serial number

personal records,

dental records,

VIN number, license plate number of a person's vehicle, and

other data as required or desired.

The stored personal information data can be secured and protected by utilizing an optional data security feature.

The microcontroller 14 is interactively connected to the USB interface 18, which provides the SafKey™ 10 with the capability to be connected to external peripherals such as scanners, printers and a network of SafKey™ related devices. Additionally, the USB interface 18 can also be used to program the SafKey™ 10 by uploading and downloading data.

The power distribution circuit 20, as shown in FIG. 1, is designed to provide a plurality of power outputs consisting of at least +5 volts d-c, +3.3 volts d-c, +3.0 volts d-c and +1.8 volts d-c. The power distribution circuit includes a rechargeable battery 20A that preferably consists of a lithium ion rechargeable battery 20A that can produce an output of 3.8 volts d-c at 70 milliamps, and a battery charging circuit 20B. The battery 20A can be recharged by an external +5 volt d-c adapter port 20C or a source applied through a USB port 20D. The charging process is automatically disabled when the battery 20A is fully charged. Likewise, the control process provided by the microcontroller 14 automatically places the process into a charging state when the recharging circuit produces a low-battery signal. As shown in FIG. 1, the power distribution circuit 20 also supplies power to illuminate an optional LED flashlight 86.

The charge state of the rechargeable battery 20A is controlled and monitored by the microwire interface 22. The microwire interface, which is interactively connected to the power distribution circuit 20 and to the microcontroller 14, has circuit means for monitoring data applicable to the charge and discharge levels of the rechargeable battery 20A. The microwire interface 22 supplies data to the microcontroller 14 in terms of “battery low”, “battery charging” and “battery fully charged”.

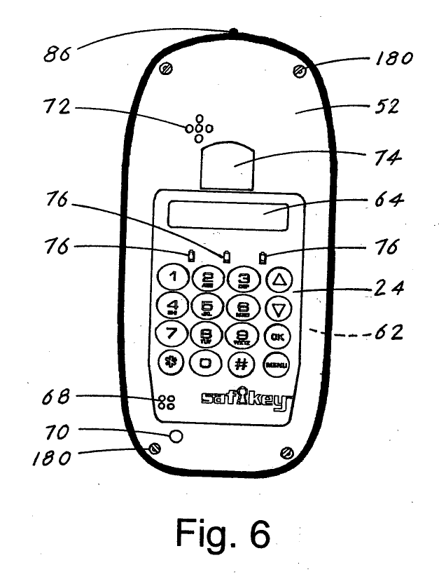

The keypad 24, as shown in the block diagram in FIG. 1, and in a front elevational view in FIG. 6, is designed to enter at least the following data into the microcontroller 14: a person's PIN, a BAC preset legal limit, a date and time, emergency medical data annunciation, and valet parking delay. The keypad 24 and can also be utilized to enter simple programming routines as may be needed to update the microcontroller 14. The primary inputs applied to the microcontroller 14 are provided by the fingerprint scanner 26, the speech pattern verifier 28, and the breath analyzer 29.

The fingerprint scanner 26, which is accessible from a surface of the enclosure 50, provides the SafKey™ 10 with the means for verifying the identity of the person that is assigned to use the key 170. In the preferred embodiment, the fingerprint scanner 26 includes a solid-state fingerprint sensor which functions as a direct-contact, fingerprint acquisition device. The sensor consists of a capacitive sensor having a two-dimensional sensing array of metal electrodes. Each metal electrode finctions as one plate of a capacitor, and the person's contacting finger functions as the second plate of the capacitor.

The ridges and valleys on a person's finger yield varying capacitive values across the array, which is read to form an image of the person's fingerprint. The fingerprint image is transmitted to the microcontroller 14 where the transmitted image is compared with the person's fingerprint image that is stored in the memory of the microcontroller 14.

The speech verifier 28 can be used either singularly or in combination with the fingerprint scanner 26 to verify the identity of a person that is assigned the use of a particular key 170. The speech verifier 28, which is accessed from a breath analyzer aperture 68 located on a surface of the enclosure 50, utilizes a password that has been pre-stored in the microcontroller 14. If the password is verified by the microcontroller 14, a speech verified signal is produced that is applied to the motor interface for further processing.

The means for verifying that a person's BAC has not exceeded a pre-stored legal limit is provided by the breath analyzer 29 which is also accessible from a surface of the enclosure 50. The breath analyzer 29 has means for accepting a breath sample from a person and providing a corresponding signal that is applied to the microcontroller 14 for verification that the person's BAC has not exceeded the maximum legal limit that is pre-stored in the microcontroller 14. The breath analyzer 29 used with the SafKey™ 10 is designed to detect ethanol concentrations from 50 to 5000 ppm, and can be designed to include a small heating element that is used to preset the breath analyzer 29 prior to its use.

If the person attempting to operate a vehicle passes both the identity verification and the BAC protocols, the d-c motor extracts the ignition key from the enclosure 50, conversely, if either the fingerprint, the speech pattern or the breath protocol is not passed, the key remains in the retracted position.

The LCD display 30 is located on a surface of the enclosure 50 and is connected to an output of the microcontroller 14, as shown in FIG. 1. The LCD display 30 allows a person to view the status of any given fuiction such as battery charge status, programming status, verification of a person's identity and sobriety, the date and time, emergency medical data, 30-day breath analyzer history and other selected items.

The extracting and retracting of the ignition key 170 is accomplished by a combination of the motor interface 32 and the d-c motor 34.

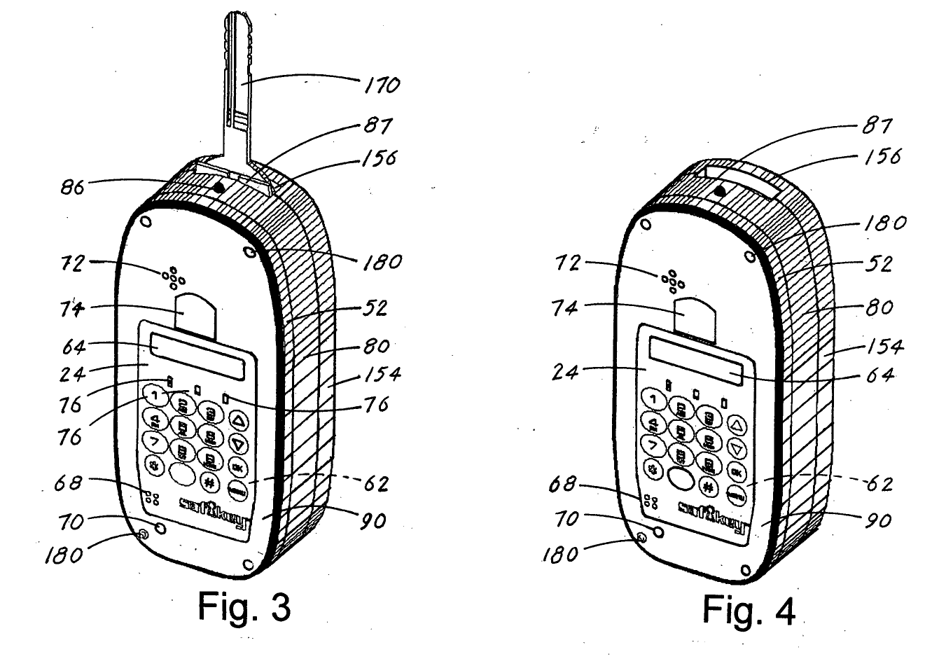

The motor interface 32, as shown in FIG. 1, is connected to and is enabled when the microcontroller 14 produces a finger verified signal, a speech verified signal and a breath verified signal. The enabled motor interface 32 is designed to supply a polarized power signal that is applied to the d-c motor 34. The d-c motor 34, in a preferred mechanization, is connected to a worm gear assembly 34A that drives a worm gear rod 108 that, as described infra, is indirectly connected to the ignition key 170. The worm gear assembly 34A either extracts the ignition key 170 from the enclosure 50 or retracts the key into the enclosure 50. The key extracting or retracting is dependent upon the polarity of the signal applied from the motor interface 32. An ignition key in the extracted position is shown in FIG. 3 and in a retracted position in FIG. 4.

The audio codec 36, which is controlled by a signal provided by the microcontroller 14, finctions as an interface circuit for powering the microphone 38 and loudspeaker 39. The audio codec 36 is designed to operate as an analog-to-digital converter (ADC) and as a digital-to-analog converter (DAC). When operating in the ADC mode a digital signal is produced that operates the microphone 38. When operating in the DAC mode an analog signal is produced that operates the loudspeaker 39. The microphone is used to store a password and to activate the speech verifier 28. Likewise, the loudspeaker 39 is used to listen to selected audio data.

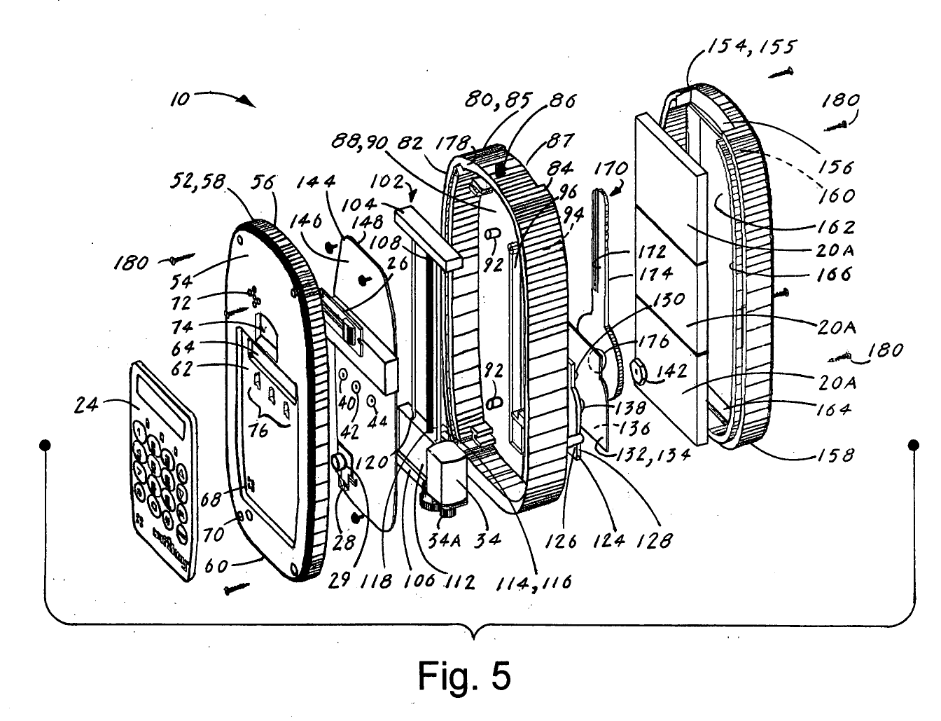

As shown in FIGS. 5 and 6, the electronics circuit 12 is further comprised of a green LED 40, an amber LED 42 and a red LED 44. The LED's function primarily to indicate the status of the rechargeable battery 20A. Namely, the red LED indicates “battery low”, the amber LED “battery charging”, and the green LED “battery fully charged”.

In addition to the above use, the three LEDs can also be used to indicate the level of a driver's intoxication. After a potential driver blows into a breath-analyzer aperture 68 located in the breath analyzer 29, the green LED 40 or amber LED 42, illuminates, blinks five times and is then extinguished. This sequence indicates that the potential driver's BAC level is below the preset legal limit that is programmed into the microcontroller 14. The acceptable limit causes the ignition key 170 to extract from the enclosure 50, thus allowing the key 170 to be inserted into a vehicle ignition lock to start the vehicle.

Conversely, if the potential driver's BAC is above a maximum legal limit, the red LED illuminates and blinks continuously for three (3) hours to allow a driver to become sober. During the illumination of the red LED 44, the ignition key remains retracted, thus the vehicle cannot be started.

As shown best in FIG. 6, the breath analyzer aperture 68 and a microphone aperture 70 are located adjacent to each other. This close proximity is provided so that a person can say a speech verification password into the microphone aperture 70 at the same time that a breath sample is blown into the breath analyzer aperture 68. Thus, preventing the person that is having their identity and BAC level verified from handing the SafKey™ 10 to a person that is not inebriated to blow a breath sample into the breath analyzer aperture 68. The microcontroller is programmed to accept a breath verified signal and a speech verified signal only if the signals are applied simultaneously.

The second major element of the SafKey™ 10 is the enclosure 50, which is shown in FIGS. 3-7. The enclosure 50, which is preferably constructed of a material that is selected from the group consisting high-impact plastic, carbon fiber and anodized aluminum, is comprised of three sections: a front cover 52, center housing 80 and a rear cover 154. The relative position of all three sections are shown in the exploded view of FIG. 5.

The front cover 52, as shown in FIGS. 5 and 6, has a front surface 54, a rear edge 56, an upper section 58 and a lower section 60. From the front surface 54 extends a keypad cavity 62 that is dimensioned to accept and retain the keypad 24. Below the upper edge of the keypad cavity 62 is an LCD display window 64, as best shown in FIG. 5, that is dimensioned and located in alignment with the LCD display 30.

Also located on the front cover 52 is a loudspeaker aperture 72 that is located in alignment with the microphone 38, a fingerprint scanner aperture 74 that is dimensioned and placed in alignment the fingerprint scanner 26, and a set of three LED windows 76 that are dimensioned and placed in alignment with the set of three LEDS 40,42,44.

The center housing 80, as shown in FIG. 5, has a front edge 82 that interfaces with and includes a means for being attached to the rear edge 56 of the front cover 52, and a rear edge 84 having an upper front key access 87. The center housing 80 also includes a key traversing structure 102 and an internal section 88 having a front surface 90 from where extends a plurality of threaded standoffs 92, a rear surface 94, and a longitudinal key traversing slot 96.

The key traversing structure 102 provides the electromechanical means by which the ignition key 170 is extracted and retracted into the enclosure 50. A key extracted from the enclosure 50 is shown in FIG. 3, and a key retracted into the enclosure 50, is shown in FIG. 4.

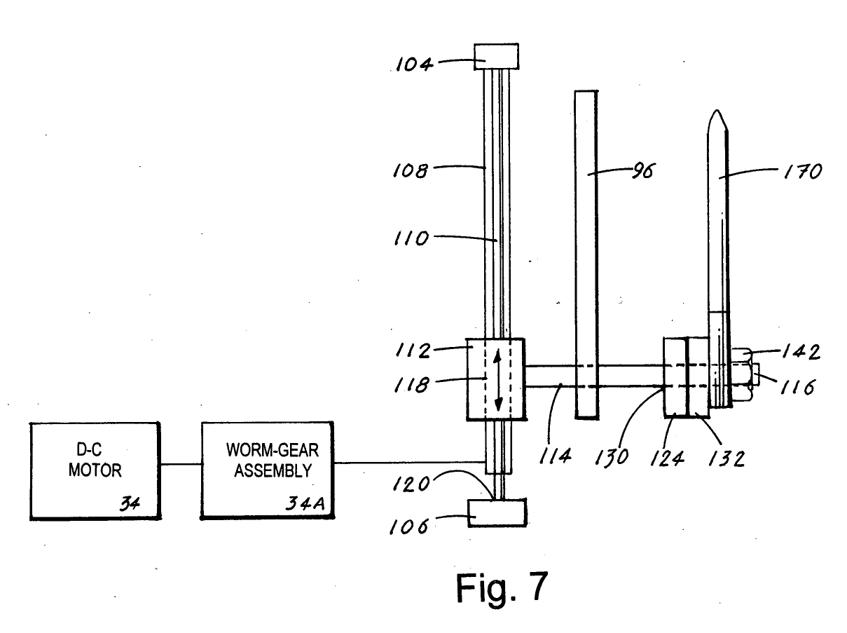

The key traversing structure 102 is shown in combination with other elements of 20 the SafKey™ 10 in FIG. 5, and in a side elevational view in FIG. 7. The key traversing structure 102 includes a means for being attached to the front surface 90 of the internal section 88 and includes an upper attachment section 104 and a lower attachment section 106. Extending from the upper and lower attachment sections 104,106 is a worm-gear rod 108 that is centered between a pair of structure stabilizing rods 110. Inserted into the worm-gear rod 108 is a geared key slider 112 that has a rearward extending, key traversing post 114 that extends through the key traversing slot 96 and that has a threaded terminus 116. The geared key slider 112 also has a geared bore 118 that is centered between a pair of structure stabilizing rod bores 120. The geared bore 118 interfaces with the worm gear rod 108 which is operated by the worm gear assembly 34A that is driven 30 by the d-c motor 34. When the worm gear assembly 34A is rotated, the key slider 112 moves in a direction as dictated by the rotational direction of the d-c motor 34.

The key traversing structure 102, as best shown in FIG. 7, is also comprised of a key pedestal 124, a two-sided adhesive tape 132, a key-retaining nut 142 and the ignition key 170. The key pedestal 124 has a front side 126, a rear side 128, and a bore 130 that is frictionally inserted over the key traversing post 114. The two-sided adhesive tape 132 has a front side 134, a rear side 136 and an opening 138 that is inserted over the key traversing post 114. The front side 134 of the tape 132 is attached to the rear side 128 of the key pedestal 124. The ignition key 170 has a front side 172 that attaches to the rear side 136 of the tape 132, a rear side 174 and an opening 176 through which extends the key traversing post 114. To provide an additional means for securing the key 170 to the key traversing post 114, a key retaining nut 142 is threaded into the threaded terminus 116 on the key traversing post 114, as best shown in FIG. 7.

The center housing 80 also encloses a two-sided printed circuit board (PCB) 144. To the first side 146 of the PCB 144 is attached the fingerprint scanner 26, the speech verifier 28, the breath analyzer 29, the microphone 38, the loudspeaker 39, and the set of three LEDS 40,42,44. To the second side 148 of the PCB 144 is attached the power distribution circuit 20, the USB interface 18, the microwire interface 22, the motor interface 32, and the audio codec 36. The PCB 144 is attached adjacent the front edge 82 of the center housing 80 by means of bolts or serrated pins that are inserted into the plurality of threaded standoffs 92 that extend from the internal section 88 on the center housing 80.

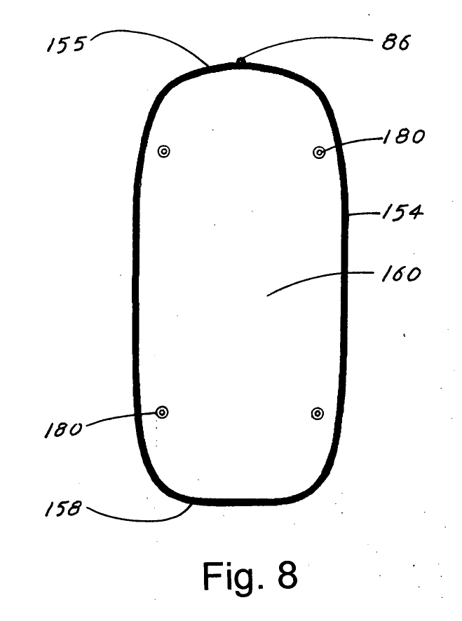

The rear cover 154, as shown in FIGS. 5 and 8, includes an upper section 155 having an upper rear key access 156, as shown in FIG. 5, that interfaces with the upper front key access 87 on the center housing 80, a lower section 158, a front edge 166 having means for being attached to the rear edge 84 of the center housing 80, and a rear planer surface 160 having an inner surface 162 further having a battery retaining bay 164 that retains the rechargeable battery 20A.

The preferred means for attaching the front cover 52, the center housing 80 and the rear cover 154 of the enclosure 50 comprises snap fit edges 178 that finctions in combination with a plurality of specially designed fasteners 180. The fastener 180 can only be inserted and removed by using a special tool, thus the enclosure 50 is made tamperproof.

While the invention has been described in detail and pictorially shown in the accompanying drawings it is not to be limited to such details, since many changes and modifications may be made to the invention without departing from the spirit and the scope thereof Hence, it is described to cover any and all modifications and forms which may come within the language and scope of the claims.

1. A biometric safety and security system comprising an enclosure containing a retracted key that can be extracted from said enclosure only after a person assigned to use said key has had their identity verified and the person's blood alcohol content (BAC) has been verified to be below a preset legal limit.

2. A biometric safety and security system comprising:
a) an electronics circuit contained within an enclosure that also encloses a key, which when not in use is in a retracted position, wherein said key can be extracted from said enclosure only after a person assigned to use said key has had their identity verified and the person's blood alcohol content (BAC) has been verified to be below a preset legal limit,
b) means for extracting and retracting said key,
c) means for verifying the identity of the person, and
d) means for verifying that the person's BAC has not exceeded a preset legal limit.

3. The system as specified in claim 2 wherein said key is comprised of a vehicle ignition key as used on automobiles, trucks, boats, buses, trains, aircraft and non-tactical military vehicles.

4. The system as specified in claim 3 wherein said means for extracting and retracting said key is provided by a d-c motor that is connected to said key via a worm gear assembly that positions said key in either the extracted or the retracted position as controlled by a microcontroller that comprises an element of the electronics circuit.

5. The system as specified in claim 4 further comprising a motor interface that is connected to said microcontroller and having means for producing a polarized power signal that is applied to and powers said d-c motor that extracts and retracts said key in accordance with the polarity of the power signal.

6. The system as specified in claim 4 wherein said d-c motor, said worm gear assembly, and said motor interface are controlled by said microcontroller.

7. The system as specified in claim 2 wherein said means for verifying the identity of a person that is assigned to use said key is comprised of a fingerprint scanner that is accessible from said enclosure, wherein when a person places a finger on said fingerprint scanner, said fingerprint scanner produces a fingerprint verification signal that is applied to said microcontroller for verification against fingerprint data that is pre-stored in said microcontroller, wherein if the person's fingerprint is verified as belonging to the person assigned to use said key, said microcontroller produces a fingerprint verified signal that is passed to said motor interface for further processing.

8. The system as specified in claim 7 wherein said means for verifing the identity of a person that is assigned to use the key is further comprised of a speech pattern verifier that is accessed via a microphone aperture located on said enclosure, wherein when a person speaks a speech verification password into said microphone, said speech pattern verifier produces a speech verification signal that is applied to said microcontroller for verification against speech pattern data that is pre-stored in said microcontroller, wherein if the person's speech pattern is verified as belonging to the person assigned to use said key, said microcontroller produces a fingerprint verified signal that is passed to said motor interface for further processing.

9. The system as specified in claim 8 wherein said means for verifing that a person's BAC has not exceeded a preset legal limit is comprised of a breath analyzer that is accessible from a breath analyzer aperture located on said enclosure, wherein said breath analyzer having means for accepting a breath sample from a person and providing a breath verification signal that is applied to said microcontroller for verification that the person's BAC has not exceeded the preset legal limit that is pre-stored in said microcontroller, wherein if the breath sample is below the maximum legal limit said microcontroller produces a breath verified signal that is passed to the motor interface for further processing.

10. The system as specified in claim 9 wherein said microcontroller is designed to process the fingerprint verification signal, the speech verification signal and the breath verification signal, wherein if all three signals are verified said microcontroller produces a verified signal that is applied to said motor interface for further processing and application to the d-c motor, wherein if both the identity and the breath protocols pass, said d-c motor extracts the ignition key conversely, if either the identity or breath protocols is not passed, the key remains in the retracted position.

11. The system as specified in claim 10 wherein said microcontroller functions with a supporting memory circuit and operates in combination with firmware to control the operation of said system electronics circuit.

12. The system as specified in claim 11 wherein said supporting memory circuit is comprised of:
a) 256 MB of NAND flash,
b) IMB of flash, and
c) 16 MB of SDRAM.

13. The system as specified in claim 3 wherein said electronics circuit further comprises a USB interface that is connected to said microcontroller, wherein said USB interface having means for allowing data applied to and from said microcontroller to be uploaded and downloaded, and to allow external peripherals to be attached and powered.

14. The system as specified in claim 13 wherein said electronics circuit further comprises a microwire interface having an input and an output, wherein the output is connected to said microcontroller.

15. The system as specified in claim 14 wherein said electronics circuits further comprises a power distribution circuit that is connected to the input of said microwire interface and that includes a rechargeable battery and a battery charging circuit, wherein said power distribution circuit produces a plurality of power outputs that are distributed to the elements comprising said electronics circuit, wherein the outputs from said power distribution circuit are processed by said microwire interface prior to application to said microcontroller.

16. The system as specified in claim 15 wherein the plurality of power outputs from said power distribution circuit comprise at least:
a)+5.0 volts d-c,
b)+3.3 volts d-c, and
c)+3.0 volts d-c.

17. The system as specified in claim 16 wherein said power distribution circuit further comprises a +5 volt d-c adapter port and a USB port that can be attached to an external power source to charge said rechargeable battery.

18. The system as specified in claim 17 wherein said electronics circuit further comprises a programmable alpha-numeric keypad that is connected to said microcontroller, includes a plurality of special finction keys and is designed to enter at least the following data into the said microcontroller:
a) a person's PIN,
b) BAC legal limit,
c) date and time,
d) emergency medical data annunciation, and
e) valet parking delay.

19. The system as specified in claim 18 wherein said electronics circuit ftirther comprises an LCD display that is connected to said microcontroller and allows a person to view at least:
a) battery status,
b) programming status,
c) personal verification data,
d) date and time,
e) emergency medication data, and
f) 30-day breath analyzer history.

20. The system as specified in claim 19 wherein said electronics circuit further comprises a microphone and a loudspeaker.

21. The system as specified in claim 20 wherein said electronics circuit further comprises an audio codec having an input connected to said microcontroller and outputs consisting of a digital signal that operates said microphone and an analog signal that operates said loudspeaker.

22. The system as specified in claim 3 further comprising a set of three LEDS that are located on said enclosure and that indicate the status of said battery in terms of “battery low”, “battery charging” and “battery fully charged”.

23. The system as specified in claim 3 wherein said electronics circuit further comprises an LED flashlight that is located on said enclosure and that is powered from an output produced by said power distribution circuit.

24. The system as specified in claim 8 wherein said microphone aperture and said breath analyzer aperture are located adjacent to each other so that a person can say a speech verification password at the same time that a breath sample is blown into said breath analyzer, thus preventing the person that is having their identity and BAC level verified from handing the system enclosure to a person that is not inebriated to blow a breath sample into said breath analyzer aperture, wherein said microcontroller is programmed to accept a password only if the password is received simultaneously with the breath sample.

25. The system as specified in claim 2 wherein said enclosure comprises:
a) a front cover having:
(1) a keypad cavity that is dimensioned to accept and retain said keypad,
(2) an LCD display window that is dimensioned and located in alignment with said LCD display,
(3) a breath analyzer aperture that is dimensioned and located in alignment with said breath analyzer,
(4) a microphone aperture that is located adjacent to said breath analyzer aperture and that is dimensioned and located in alignment with said microphone,
(5) a loudspeaker aperture that is dimensioned and located in alignment with said loudspeaker,
(6) a fingerprint scanner opening that is dimensioned and placed in alignment with said fingerprint scanner, and
(7) a set of three LED windows that are dimensioned and placed in alignment with a set of three LEDS,
b) a center housing having:
(1) means for being attached to said front cover,
(2) an upper front key access,
(3) an internal section having a longitudinal key traversing slot,
c) a key traversing structure having means for being attached to said internal section, said structure having:
(1) a worm gear rod centered between a pair of structure stabilizing rods that extend from an upper and a lower attachment section,
(2) a key slider having a rearward extending key traversing post and a geared bore centered between a pair of structure stabilizing rod bores that are dimensioned to slide along the structure stabilizing rods, wherein the geared bore interfaces with the worm gear rod which is operated by said worm gear assembly that is driven by said d-c motor, wherein when said worm gear assembly rotates, said key slider moves in a direction as dictated by the rotational direction of said d-c motor,
(3) a key pedestal having a bore that is placed over the key traversing post,
(4) means for attaching a key to said key pedestal,
d) a two-sided printed circuit board (PCB) that is attached to said center housing by an attachment means, wherein to the first side of said PCB is attached said fingerprint scanner, said speech pattern verifier, said breath analyzer, said microphone, said loudspeaker, and said set of three LEDS, wherein to the second side of said PCB is attached said power distribution circuit, said USB interface, said microwire interface, said motor interface and said audio codec, and
e) a rear cover having:
(1) an upper section having an upper rear key access that interfaces with the front key access on said center section,
(2) means for being attached to said center section, and
(3) a rear surface with an inner surface having a battery retaining bay that retains said rechargeable battery.

26. The system as specified in claim 25 wherein said means for attaching said front cover, said center housing and said rear cover of said enclosure comprises a snap-fit and a plurality of specially designed fasteners that can only be inserted and removed by using a special tool, thus said enclosure is made tamperproof.

27. The system as specified in claim 26 wherein said enclosure is constructed of a material selected from the group consisting of high-impact plastic, carbon fiber and anodized aluminum.

28. A biometric safety and security system comprising an electronics circuit contained within an enclosure which also encloses a key that when not in use is in a retracted position, wherein said key can be extracted only after a person assigned to use said key has had their identity verified and the person's blood alcohol content (BAC) has been verified to be below a preset legal limit, said electronics circuit comprising:
a) a microcontroller that fimctions in combination with a memory circuit to control the operation of said electronics circuit,
b) a universal serial bus (USB) interface that is connected to said microcontroller, said USB interface having means for allowing data supplied to and from said microcontroller to be uploaded and downloaded and to allow external peripherals to be attached and powered,
c) a microwire interface having an input and an output, wherein the output is connected to said microcontroller,
d) a power distribution circuit that is connected to the input of said microwire interface and that includes a rechargeable battery and a battery charging circuit, wherein said power distribution circuit produces a plurality of power outputs that are distributed to the elements comprising said electronics circuit, wherein the outputs from said power distribution circuit are processed by said microwire interface prior to applying the outputs to said microcontroller, wherein said power distribution circuit further comprises a +5 volt d-c adapter port and a USB port that can be attached to an external power source to charge said rechargeable battery,
e) a programmable keypad that is connected to said microcontroller, and that is designed to enter at least the following data:
(1) a person's PIN,
(2) BAC legal limit,
(3) date and time,
(4) emergency medical data, and
(5) valet parking delay.
f) a first means for verifying the identity of a person that is assigned to use said key comprises a fingerprint scanner that is connected to said microcontroller and is accessible from said enclosure, wherein when a person places a finger on said fingerprint scanner, said scanner produces a fingerprint verification signal that is applied to said microcontroller for verification against fingerprint data that is pre-stored in said microcontroller, wherein if the person's fingerprint is verified as belonging to the person assigned to use said key, said microcontroller produces a fingerprint verified signal that is passed to said electronics circuit for further processing,
g) a second means for verifying the identity of a person that is assigned to use the key is further comprised of a speech pattern verifier that is accessed via a microphone aperture located on said enclosure, wherein when a person speaks a speech verification password into said microphone, said speech pattern verifier produces a speech verification signal that is applied to said microcontroller, wherein if the person's speech pattern is verified as belonging to the person assigned to use said key, said microcontroller produces a fingerprint verified signal that is passed to said motor interface for further processing,
h) a breath analyzer having means for accepting a breath sample from a 15 person and providing a breath verification signal that is applied to said microcontroller for verification that the person's blood alcohol content (BAC) has not exceeded a preset legal limit that is pre-stored in said microcontroller, wherein if both the identity and breath protocols pass, the ignition key is extracted conversely, if either the identity or the breath protocol is not passed, the key remains in the retracted position,
i) an LCD display that is connected to said microcontroller and allows a person to view at least:
(a) battery status,
(b) programming status,
(c) verification of person's identity and sobriety,
(d) date and time,
(e) emergency medical data, and
(f) 30-day breath analyzer history.
j) a d-c motor that is connected to said key via a worm gear assembly that positions said key in either the extracted or the retracted position as controlled by said microcontroller,
k) a motor interface that is connected to said microcontroller and having means for producing a polarized power signal that is applied to and powers said d-c motor that extracts and detracts said key in accordance with the polarity of the applied power signal,
l) a microphone,
m) a loudspeaker,
n) an audio codec having an input connected to said microcontroller and outputs consisting of a digital signal that is connected to and operates said microphone and an analog signal that is connected to and operates said loudspeaker, and
o) a set of three LEDS that are located on said enclosure and that indicate the status of said battery in terms of “battery low”, “battery charging” and “battery fully charged”.

29. The system as specified in claim 28 wherein said microcontroller having means for providing at least the following functions:
a) signal processing,
b) peripheral control,
c) data transfer,
d) power management, and
e) data storage.

30. The system as specified in claim 29 wherein said microcontroller is supported by said memory circuit which comprises 256 MB of NAND flash, 1 MB of flash, and 16 MB of SDRAM.

31. The system as specified in claim 30 wherein the data storage of said microcontroller includes the capability of storing a multiplicity of individual person's fingerprints and personal identification numbers (PIN).

32. The system as specified in claim 28 wherein said rechargeable battery is comprised of a lithium ion battery.

33. The system as specified in claim 28 wherein the plurality of power outputs from said power distribution circuit comprises at least:
a) +5.0 volts d-c,
b) +3.3 volts d-c,
c) +3.0 volts d-c, and
d) +1.8 volts d-c.

34. The system as specified in claim 28 wherein said microwire interface having means for monitoring at least data applicable to the charge and discharge levels of said rechargeable battery and for supplying the data to said microcontroller in terms of “battery low”, “battery charging” and “battery fully charged”.

35. The system as specified in claim 28 wherein said keypad is comprised of a programmable alpha-numeric keypad having at least six special function keys.

36. The system as specified in claim 28 further comprising an LED flashlight that is located on a surface of said enclosure and that is powered by an output provided by said power distribution circuit.

37. The system as specified in claim 28 wherein said breath analyzer is designed to maintain a 30-day record of a person's alcohol consumption.

38. The system as specified in claim 28 wherein said enclosure comprises:
a) a front cover having:
(1) a front surface,
(2) a rear edge,
(3) an upper section,
(4) a lower section,
(5) a keypad cavity that extends from the front surface and that is dimensioned to accept and retain said keypad,
(6) an LCD display window that is dimensioned and located in alignment with said LCD display,
(7) a breath analyzer aperture that is dimensioned and located in alignment with said breath analyzer,
(8) a microphone aperture that is adjacent to said breath analyzer aperture and that is dimensioned and located in alignment with said microphone,
(9) a loudspeaker aperture that is dimensioned and located in alignment with said loudspeaker,
(10) a fingerprint scanner opening that is dimensioned and placed in alignment with said fingerprint scanner, and
(11) a set of three LED windows that are dimensioned and placed in alignment with said set of three LEDS,
b) a center housing having:
(1) a front edge that interfaces with and includes a means for being attached to the rear edge of said front cover,
(2) a rear edge having upper front key access,
(3) an internal section having a front surface from where extend a plurality of threaded standoffs, a rear surface and a longitudinal key traversing slot,
c) a key traversing structure having means for being attached to the front surface of said internal section, said structure having:
(1) an upper attachment section,
(2) a lower attachment section,
(3) a worm-gear rod centered between a pair of structure stabilizing rods, wherein all three said rods extend from the upper attachment section and the lower attachment section,
(4) a geared key slider having a rearward extending, key traversing post that extends through the key traversing slot and that has a treaded terminus and a geared bore centered between a pair of structure stabilizing rod bores, wherein the geared bore interfaces with the worm gear rod which is operated by said worm gear assembly that is driven by said d-c motor, wherein when said worm gear assembly is rotated, said key slider moves in a direction as dictated by the rotational direction of said d-c motor,
(5) a key pedestal having a front side, a rear side, and a bore that is frictionally inserted over the key traversing post,
(6) a two-sided adhesive tape having a front surface, a rear surface, and an opening that is inserted over the key traversing post, wherein the front side of said tape is attached to the rear side of said key pedestal,
(7) a key having a front side, a rear side and an opening through which extends said key traversing post, wherein the front side of said key is attached to the rear side of said two-sided adhesive tape,
(8) a key-retaining nut that is threaded into the threaded terminus on said key traversing post, wherein said nut is dimensioned to provide an additional means for securing said key to said key traversing post,
d) a two-sided printed circuit board (PCB), wherein to the first side of said PCB is attached said fingerprint scanner, said speech pattern verifier, said breath analyzer, said microphone, said loudspeaker, and said set of three LEDS, wherein to the second side of said PCB is attached said power distribution circuit, said USB interface, said microwire interface, said motor interface and said audio codec, wherein said PCB is attached adjacent the front edge of said center housing by means of screws or serrated pins that are inserted into the plurality of threaded standoffs that extend from the internal section on said center housing and
e) a rear cover having:
(1) an upper section having an upper rear key access that interfaces with the front key access on said center housing,
(2) a lower section,
(3) a front edge having means for being attached to the rear edge of said center housing, and
(4) a rear surface with an inner surface having a battery retaining bay that retains said rechargeable battery.

39. The system as specified in claim 25 wherein the front cover, center housing and the rear cover of said enclosure are fastened by snap fasteners and a plurality of specially designed fasteners that can only be inserted and removed by using a special tool, thus said enclosure is made tamperproof.

40. The system as specified in claim 26 wherein said enclosure is constructed of a material selected from the group consisting of a high-impact plastic, a carbon fiber and anodized aluminum.
